(19) United States
(12) Patent Application Publication
(10) Pub. No.: US 2025/0391185 A1
(43) Pub. Date: Dec. 25, 2025

(54) SYSTEM AND METHOD FOR RECOGNIZING VERTICALLY ORIENTED ALPHANUMERIC TEXT IN IMAGES

(71) Applicant: Quantiphi, Inc, Marlborough, MA (US)

(72) Inventors: Reghupathi Hariharan, Marlborough, MA (US); Akhil Ram Adapa V S S R, Mumbai (IN); Vikrant Satish Chatole, Mumbai (IN); Aakarsh Gupta, Mumbai (IN)

(73) Assignee: Quantiphi, Inc, Marlborough, MA (US)

(21) Appl. No.: 18/751,848

(22) Filed: Jun. 24, 2024

(51) Int. Cl. G06V 30/10; G06F 40/109; G06T 3/60; G06T 5/50; G06V 10/24; G06V 10/25

(52) U.S. Cl. CPC G06V 30/10; G06F 40/109; G06T 3/60; G06T 5/50; G06V 10/242; G06V 10/25; G06T 2207/20221

(57) ABSTRACT

A system for recognizing vertically oriented alphanumeric text in images, the system including a processor configured to receive one or more images comprising vertically oriented alphanumeric text and detect one or more regions-of-interest in each image via a trained text detector. The processor is configured to execute a cropping of the detected one or more regions-of-interest encompassing vertically oriented alphanumeric text from each image to obtain one or more text crop portions and rotate the one or more text crop portions to obtain one or more orthogonally rotated text crop portions. The processor is configured to execute a trained ensemble of two different text recognition models on each of the obtained one or more text crop portions and the one or more orthogonally rotated text crop portions and generate a set of candidate recognized text strings based on the executed trained ensemble and determine a final recognized text string.

### FIELD OF TECHNOLOGY

The present disclosure relates generally to the field of text recognition in images. Specifically, the present disclosure relates to a system and a method for recognizing vertically oriented alphanumeric text in images.

### BACKGROUND

Advancements in the field of optical character recognition (OCR) have gained popularity over the years due to the plethora of applications, such as document digitization, automated data extraction, and efficient information retrieval. The OCR technology plays a significant role in converting printed or handwritten text into machine-readable format, enabling efficient processing and analysis of textual data. The OCR technology finds applications in various domains, including document management, archival systems, text recognition in images, and automated data entry. The ability to accurately extract and interpret text from diverse sources has led to significant advancements in OCR algorithms and techniques, contributing to the development of more robust and reliable OCR systems. However, despite the progress made in the OCR technology, there are still challenges and limitations in the general domain. One of the major challenges is the recognition of vertically oriented alphanumeric text, which is relatively rare in real-world scenarios.

The existing OCR systems, including those offered by prominent cloud service providers, such as Google cloud platform (GCP), Amazon web services (AWS), and Microsoft Azure, are tested for detecting and recognizing the vertically oriented alphanumeric characters. Despite their proficiency in handling horizontal text layouts, the aforementioned OCR systems fail to detect and recognizing the vertically oriented numbers or alphabets present in the text. Moreover, the experiments have been done for recognizing the vertically oriented alphanumeric characters using the existing open-source models, trained on widely used text spotting datasets, like IC13 and IC15. The existing models and datasets are primarily tailored to handle the horizontally oriented text. Therefore, the existing models and datasets do not yield satisfactory results when confronted with the vertically oriented alphanumeric characters. One of the primary reasons for this deficiency is the scarcity of vertically oriented text instances in natural environments. Unlike horizontal text, which is ubiquitous in printed materials and digital content, vertically oriented alphanumeric text occurrences are comparatively rare. Consequently, the lack of sufficient training data exacerbates the challenge of developing robust OCR solutions for such scenarios. Thus, due to minimal prevalence of the vertically oriented text in real-world scenarios, the recognition of the vertically oriented alphanumeric text remains a significant challenge in the realm of OCR technology. The existing solutions, although proficient in handling the horizontal text layouts, are inadequate when confronted with vertical arrangements of text layouts.

Further limitations and disadvantages of conventional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a system and a method for recognizing vertically oriented alphanumeric text in images. The present disclosure seeks to provide a solution to the existing problem of how to accurately recognize the vertically oriented alphanumeric text in images. An aim of the present disclosure is to provide a solution that overcomes at least partially the problems encountered in the prior art and provide an improved system that accurately recognize the vertically oriented alphanumeric text in images. Additionally, the disclosure aims to offer an improved method that empowers the identification of vertically oriented alphanumeric text in images with an improved accuracy and reliability.

In one aspect, the present disclosure provides a system for recognizing vertically oriented alphanumeric text in images, the system comprising a processor configured to receive one or more images comprising vertically oriented alphanumeric text with respect to a ground plane. The processor is further configured to detect one or more regions-of-interest in each image of the one or more images, via a trained text detector, the one or more regions-of-interest comprising the vertically oriented alphanumeric text and execute a cropping of the detected one or more regions-of-interest encompassing corresponding vertically oriented alphanumeric text from each image of the one or more images to obtain one or more text crop portions. The processor is further configured to rotate the one or more text crop portions by 90 degrees to obtain one or more orthogonally rotated text crop portions and execute a trained ensemble of two different text recognition models on each of the obtained one or more text crop portions and the one or more orthogonally rotated text crop portions. The processor is further configured to generate a set of candidate recognized text strings based on the executed trained ensemble of two different text recognition models and determine a final recognized text string from the generated set of candidate recognized text strings based on a defined camera based parameter and a text-character frequency parameter.

The disclosed system enables an efficient recognition of the vertically oriented alphanumeric text with enhanced accuracy (e.g., 90.2%) and reliability. The disclosed system uses the trained text detector to identify the one or more regions-of-interest that comprises the vertically oriented alphanumeric text. The use of the trained text detector ensures the more accurate identification of the regions comprising the vertically oriented alphanumeric text (such as, trailer's number, carrier's number, license number, USDOT number, etc.) in each image. Moreover, the disclosed system uses the trained ensemble of two different text recognition models that is the first text recognition model and the second text recognition model, which recognize the vertically oriented alphanumeric text with more reliability and efficiency. Each of the first text recognition model and the second text recognition model is trained using the synthetic as well as real-world alphanumeric text samples, which make the first text recognition model and the second text recognition model more proficient in recognizing the vertically oriented alphanumeric text. Moreover, the system ensures that the most confident and repeating texts found, are given more weight and the final text string is selected based on number of views found (e.g., the left view, right view, rear view, front view, etc.) and based on the weight or frequency of occurrence of the final text string. Consequently, the final text string is selected with an enhanced accuracy and reliability and in a much faster way.

In another aspect, the present disclosure provides a method comprising receiving, by a processor, one or more images comprising vertically oriented alphanumeric text with respect to a ground plane. The method further comprises detecting, by the processor, one or more regions-of-interest in each image of the one or more images, via a trained text detector, the one or more regions-of-interest comprising the vertically oriented alphanumeric text and executing, by the processor, a cropping of the detected one or more regions-of-interest encompassing corresponding vertically oriented alphanumeric text from each image of the one or more images to obtain one or more text crop portions. The method further comprises rotating, by the processor, the one or more text crop portions by 90 degrees to obtain one or more orthogonally rotated text crop portions and executing, by the processor, a trained ensemble of two different text recognition models on each of the obtained one or more text crop portions and the one or more orthogonally rotated text crop portions. The method further comprises generating, by the processor, a set of candidate recognized text strings based on the executed trained ensemble of two different text recognition models and determining, by the processor, a final recognized text string from the generated set of candidate recognized text strings based on a defined camera based parameter and a text-character frequency parameter.

The method achieves all the advantages and technical effects of the system of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not too scaled. Wherever possible, like elements have been indicated by identical numbers.

Embodiments of the present disclosure will now be described, by way of example only, with reference to the following diagrams wherein:

FIG. 1 is a block diagram illustrating a system for recognizing vertically oriented alphanumeric text in images, in accordance with an embodiment of the present disclosure;

FIG. 2 is a diagram illustrating a subnetwork for detection and recognition of vertically oriented alphanumeric text, in accordance with an embodiment of the present disclosure;

FIG. 3 is a diagram illustrating an overall solution architecture to display all information of vehicles entering to or exiting from a warehouse, in accordance with an embodiment of the present disclosure;

FIG. 4A is a diagram illustrating an exemplary implementation scenario of detection of vertically oriented alphanumeric text on a vehicle exiting from a warehouse, in accordance with an embodiment of the present disclosure;

FIG. 4B is a diagram illustrating an exemplary implementation scenario of detection of vertically oriented alphanumeric text on a vehicle exiting from a warehouse, in accordance with another embodiment of the present disclosure; and

FIG. 5 is a flowchart of a method for recognizing vertically oriented alphanumeric text in images, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

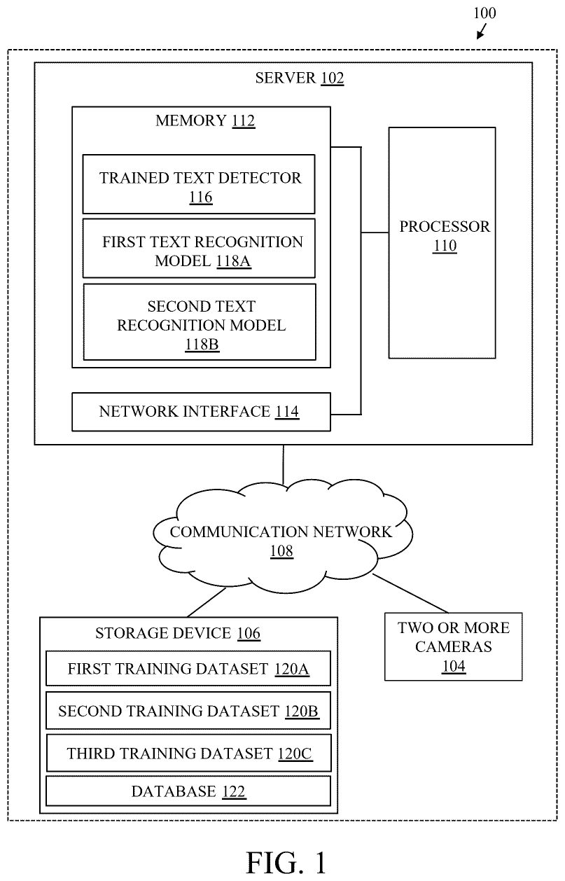

FIG. 1 is a block diagram illustrating a system for recognizing vertically oriented alphanumeric text in images, in accordance with an embodiment of the present disclosure. With reference to FIG. 1, there is shown a block diagram of a system 100 that may include a server 102, two or more cameras 104 and a storage device 106 connected to each other via a communication network 108. The server 102 may include a processor 110, a memory 112 and a network interface 114. The processor 110 may be communicatively coupled with the memory 112 and the network interface 114. The memory 112 may store a trained text detector 116, a first text recognition model 118A and a second text recognition model 118B. The storage device 106 may store a first training dataset 120A, a second training dataset 120B, a third training dataset 120C and a database 122.

In an implementation, the storage device 106 may be a part of the memory 112 of the server 102. In another implementation, the storage device 106 may not be a part of the memory 112 and act as an independent unit that is connected to the memory 112, as shown in FIG. 1. In an implementation, the processor 110, the memory 112 and the network interface 114 may be implemented on a same server, such as the server 102.

The present disclosure provides the system 100 for recognizing vertically oriented alphanumeric text in images with enhanced accuracy and reliability. The system 100 is configured to obtain the one or more images comprising vertically oriented alphanumeric text with respect to the ground plane. The system 100 is further configured to use the trained text detector 116 for detecting the one or more regions-of-interest comprising the vertically oriented alphanumeric text from each of the obtained one or more images. The trained text detector 116 is trained using the third training dataset 120C, generated by overlaying alphanumeric characters on backgrounds scraped from various trailers and applying realistic font styles commonly found in a trucking industry. The system 100 is further configured to crop the detected one or more regions-of-interest from each image which encompass the vertically oriented alphanumeric text. The system 100 is further configured to rotate the one or more text crop portions by 90 degrees to obtain one or more orthogonally rotated text crop portions and execute the trained ensemble of two different text recognition models, such as the first text recognition model 118A and the second text recognition model 118B on the obtained one or more text crop portions and the one or more orthogonally rotated text crop portions. The first text recognition model 118A is trained using the first training dataset 120A comprising a plurality of vertically oriented synthetic and real-world alphanumeric text samples. Similarly, the second text recognition model 118B is trained using the second training dataset 120B comprising a plurality of rotated vertically oriented synthetic and real-world alphanumeric text samples. The system 100 is further configured to generate a set of candidate recognized text strings based on the executed trained ensemble of two different text recognition models and determine a final recognized text string from the generated set of candidate recognized text strings based on a defined camera based parameter and a text-character frequency parameter. The system 100 as well as various components of the system 100 are described in more detail, in the following way.

The server 102 is configured to communicate with the two or more cameras 104 and the storage device 106 via the communication network 108. In an implementation, the server 102 may be a master server or a master machine that is a part of a data center that controls an array of other cloud servers communicatively coupled to it for load balancing, running customized applications, and efficient data management. Examples of the server 102 may include, but are not limited to a cloud server, an application server, a data server, or an electronic data processing device.

The two or more cameras 104 may be configured to capture one or more images comprising vertically oriented alphanumeric text with respect to a ground plane. Examples of the two or more cameras 104 may include, but are not limited to, a color camera, a digital single lens reflex (DSLR) camera, a single lens reflex (SLR) camera, a mirrorless camera, a three-dimensional (3D) camera, and the like.

The storage device 106 may refer to a storage location where data is stored, managed, and organized in a structured manner. The storage device 106 may serve as a centralized and secure storage facility for various types of data, such as the first training dataset 120A, the second training dataset 120B, the third training dataset 120C and the database 122, and thus, may allow efficient retrieval, sharing, and management of information.

The communication network 108 includes a medium (e.g., a communication channel) through which the two or more cameras 104 and the storage device 106 communicates with the server 102. The communication network 108 may be a wired or wireless communication network. Examples of the communication network 108 may include, but are not limited to, a local area network (LAN), a wireless personal area network (WPAN), a wireless local area network (WLAN), a wireless wide area network (WWAN), a cloud network, a long-term evolution (LTE) network, a metropolitan area network (MAN), and/or Internet.

The processor 110 refers to a computational element that is operable to respond to and processes instructions that drive the system 100. The processor 110 may refer to one or more individual processors, processing devices, and various elements associated with a processing device that may be shared by other processing devices. Additionally, the one or more individual processors, processing devices, and elements are arranged in various architectures for responding to and processing the instructions that drive the system 100. In some implementations, the processor 110 may be an independent unit and may be located outside the server 102 of the system 100. Examples of the processor 110 may include but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The memory 112 refers to a volatile or persistent medium, such as an electrical circuit, magnetic disk, virtual memory, or optical disk, in which a computer can store data or software for any duration. Optionally, the memory 112 is a non-volatile mass storage, such as a physical storage media. Furthermore, a single memory may encompass and, in a scenario, and the system 100 is distributed, the processor 110, the memory 112 and/or storage capability may be distributed as well. Examples of implementation of the memory 112 may include, but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

The network interface 114 refers to a communication interface to enable communication of the server 102 to any other external device, such as the two or more cameras 104 and the storage device 106. Examples of the network interface 114 include, but are not limited to, a network interface card, a transceiver, and the like.

The trained text detector 116 may be configured to detect one or more regions comprising vertically oriented alphanumeric text, from each image of the one or more images captured by the two or more cameras 104.

Each of the first text recognition model 118A and the second text recognition model 118B may be referred to as an artificial intelligence (AI) model designed to identify and extract text (including vertical oriented alphanumeric text as well as horizontal text layouts) from images or documents. Each of the first text recognition model 118A and the second text recognition model 118B may use various techniques from computer vision and natural language processing to detect and recognize vertically oriented text as well as horizontally oriented text within images or scanned documents.

In operation, the system 100 comprising the processor 110 is configured to receive one or more images comprising vertically oriented alphanumeric text with respect to a ground plane. In an implementation, the received one or more images may represent the information related to all vehicle traffic entering to or exiting from a warehouse. The vehicle traffic may include ‘trucks with trailers’, ‘tractor without trailer’ and other vehicles. The other vehicles are vehicles like, parcel service trucks, equipment service trucks, bobcats, propane cylinder trucks, etc. that require logging but have no trailer information associated with them. The ‘tractor without trailer’ is mostly a remote-controlled technique owned tractor that is returning from delivering a shipment, or to pick up a shipment. The ‘trucks with trailers’ correspond to tractors bringing in shipments or taking out shipments loaded in trailers. All such vehicles are marked with various numbers, slogans, uniform resource locator (URL), phone numbers, safety information, carrier names, and the like. The vertically oriented alphanumeric text may include various numbers including a trailer number, a vehicle identification number, (VIN), a motor carrier (MC) number, a United States department of transportation (USDOT) number, a tractor carrier name, a trailer carrier name, a license number plate, and the like, marked on each vehicle of the vehicle traffic.

The processor 110 is further configured to detect one or more regions-of-interest in each image of the one or more images, via the trained text detector 116, the one or more regions-of-interest comprising the vertically oriented alphanumeric text. The one or more regions-of-interest correspond to the regions on each vehicle where the vertically oriented alphanumeric text is available. For example, the USDOT number is typically displayed on both sides of a commercial vehicle, usually on the doors of a cab or a trailer. The USDOT number is often written in a contrasting color to make it easily visible. The tractor carrier name or name of an operating organization is commonly displayed on both sides of the tractor cab, usually near the door or along the cab's body. The trailer carrier number may also be displayed on both sides of the trailer, usually near the front or rear of the trailer body. Approximately, 75-80% of the trailers, the trailer carrier number is written vertically and is one of the few text-spotting scenarios in the real world where, the alphanumeric text is oriented vertically. The usage of the vertical alphanumeric text for the trailer carrier number is so that the workers working at the warehouse may read the trailer number off the front edge of the trailer. The license plate number is usually displayed on front or rear of the vehicle, attached to the bumpers or designated areas. In some cases, the license plate number may also be displayed on the sides of the vehicle. The trained text detector 116 may be specifically configured to detect the trailer number in the vertically oriented alphanumeric text. The trailer number is a unique identifier of each trailer along with its carrier and is used by the warehouse workers to identify, manage and perform downstream tasks on shipments and trailers.

In some implementations, the processor 110 is configured to train the trained text detector 116 using the third training dataset 120C generated by overlaying alphanumeric characters on backgrounds scraped from various trailers and applying realistic font styles commonly found in trucking industry. The third training dataset 120C may be used to fine-tune the trained text detector 116 based on real image samples (e.g., 50K) as well as synthetic image samples (e.g., 50K). The synthetic image samples are generated using the following: alphanumeric characters are overlaid on backgrounds, scraped from various trailers at different sizes, width and height ratios. Moreover, the fonts styles of the alphanumeric characters are chosen based on the commonly used font styles and sizes for trucks and trailers.

In some implementations, the generated third training dataset 120C further comprises synthetic images generated by: sampling background images from the real images of vehicle trailers, rendering vertically oriented text strings onto the sampled background images using fonts commonly found on vehicle trailers, and applying one or more data augmentation techniques to the rendered text strings. The synthetic image samples (or synthetic images) comprised by the third training dataset 120C may be generated using a variety of text sampling methods, such as random text, substrings sampled from a trailer database, full text sampled from the trailer database.

In some implementations, the one or more data augmentation techniques comprise one or more of: skewing, perspective transforming, adjusting character spacing, adding noise patterns, or applying spatial dropout. The skewing is a data augmentation technique, includes applying a transformation to an image that distorts the image's geometry by changing the angles of the objects within the image. The skewing can be performed in various ways including horizontal skewing (shearing), vertical skewing or both simultaneously. The adjust character spacing, also known as kerning, is commonly used in OCR tasks, especially for handwritten or printed text recognition. The kerning involves modifying the spacing between characters in a text image to simulate variations in handwriting styles or printing conditions. The spatial dropout is a regularization technique specifically designed for convolutional neural networks, used to prevent overfitting and improve the generalization ability of the trained text detector 116 by randomly dropping entire features maps during training.

The one or more data augmentation techniques are used to generate more synthetic image samples from real images by applying various transformation to the original data. The use of the one or more data augmentation techniques may increase the diversity of the third training dataset 120C by introducing variations, such as rotations, translations, flipping, cropping, brightness adjustments, noise addition, and the like. By exposing the trained text detector 116 to a wide range of data variations, robustness and performance of the trained text detector 116 can be enhanced relative to changes in input conditions, such as different lighting conditions, occlusions, deformations and other factors that may be encountered in real-world scenarios.

The processor 110 is further configured to execute a cropping of the detected one or more regions-of-interest encompassing corresponding vertically oriented alphanumeric text from each image of the one or more images to obtain one or more text crop portions. After detection of the one or more regions-of-interest comprising the vertically oriented alphanumeric text (e.g., a trailer number, USDOT number, tractor carrier name, trailer carrier name, and license number plate), the one or more regions-of-interest are cropped from each image which, leads to a more accurate detection and recognition of the vertically oriented alphanumeric text and also, a fast processing of the one or more text crop portions.

The processor 110 is further configured to rotate the one or more text crop portions by 90 degrees to obtain one or more orthogonally rotated text crop portions. The one or more text crop portions comprises the vertically oriented alphanumeric text (i.e., the trailer number, USDOT number, tractor carrier name, trailer carrier name, and license number plate) and the one or more orthogonally rotated text crop portions comprises the orthogonally rotated vertically oriented alphanumeric text. The orthogonally rotated vertically oriented alphanumeric text refer to vertical text that has been rotated by 90 degrees (orthogonally) from its original orientation. Instead of being oriented vertically from top to bottom, the text is now oriented horizontally from left to right. In an implementation, the trailer number may be split into two separate classes, such as a horizontal trailer number and a vertical trailer number. The horizontal trailer number is detected using an ensemble solution based on a Paddle OCR and Form recognizer. The vertical trailer number, which is present on most of the trailers, undergo a different detection process that includes OCR models trained on custom datasets paired with an ensemble decision maker.

The processor 110 is further configured to execute a trained ensemble of two different text recognition models on each of the obtained one or more text crop portions and the one or more orthogonally rotated text crop portions. The vertical trailer number is detected using the trained ensemble of two different text recognition models or two different OCR models, for example, a paddle OCR and a transformer-based OCR model. The paddle OCR and the transformer-based OCR (Tr-OCR) model is executed on each of the obtained one or more text crop portions (i.e., the detected vertical trailer number) and the one or more orthogonally rotated text crop portions (i.e., the orthogonally rotated vertical trailer number). The usage of the trained ensemble ensures the reliable recognition of the vertically oriented alphanumeric text.

Conventionally, only one OCR model is used for text recognition in images, therefore, conventional systems used for recognition of vertically oriented alphanumeric text lack accuracy and reliability. However, the system 100 employs the use of the trained ensemble of two different text recognition models, one for the one or more text crop portions and another for the one or more orthogonally rotated text crop portions. Thus, the system 100 manifests an improved text recognition accuracy (e.g., 90.2%) from the images.

In some implementations, the trained ensemble of two different text recognition models comprises the first text recognition model 118A trained on the first training dataset 120A comprising a plurality of vertically oriented synthetic and real-world alphanumeric text samples. In an implementation, the first text recognition model 118A may correspond to a deep learning model, for example a Paddle OCR model (or a PPOCRv4 model), which is trained on the first training dataset 120A. Typically, the Paddle OCR model is an open-source OCR model, designed to recognize text from images with high accuracy and efficiency. The Paddle OCR model is widely used in applications requiring text extraction from images, such as document scanning, image-based translation, and augmented reality. The first training dataset 120A comprises, for example, 50K images including real-world alphanumeric text samples and 50K images of synthetic vertical samples. The 50K synthetic samples are generated using the aforementioned one or more data augmentation techniques.

In some implementations, the trained ensemble of two different text recognition models comprises the second text recognition model 118B trained on the second training dataset 120B comprising a plurality of rotated vertically oriented synthetic and real-world alphanumeric text samples. Similar to the first text recognition model 118A, the second text recognition model 118B may also correspond to a deep learning model, for example a transformed OCR (Tr-OCR) model, which is trained on the second training dataset 120B. Typically, the Tr-OCR model can effectively capture dependencies between characters in an input image, hence, allows an accurate text recognition even in complex scenarios, such as multi-language texts, skewed or distorted characters, and various fonts. The second training dataset 120B comprises, for example, 50K images including real-world alphanumeric text samples and 50K images of synthetic rotated vertical samples (i.e., orthogonally rotated vertically oriented samples). The 50K synthetic rotated vertical samples are generated using the aforementioned one or more data augmentation techniques.

The processor 110 is further configured to generate a set of candidate recognized text strings based on the executed trained ensemble of two different text recognition models. Each of the first text recognition model 118A and the second text recognition model 118B is executed on the one or more text crop portions and the one or more orthogonally rotated text crop portions, respectively. After execution, outputs are generated in form of the set of candidate recognized text strings from each of the first text recognition model 118A and the second text recognition model 118B.

The processor 110 is further configured to determine a final recognized text string from the generated set of candidate recognized text strings based on a defined camera based parameter and a text-character frequency parameter. The generated set of candidate recognized text strings are compared with a threshold value. On comparison, the text strings having low confidences are thresholded out and the text strings with high confidences are added to a counting dictionary that maintains the found text strings and their respective camera views. The final recognized text string (e.g., a vertical trailer number) is determined from the generated set of candidate recognized text strings based on which text string is recognized across camera views and which text string is most frequently recognized.

In some implementations, the defined camera-based parameter is indicative of a number of camera views from which the detected region-of-interest is captured, and where a candidate recognized text string from the generated set of candidate recognized text strings identified in the same detected region-of-interest by the two or more cameras 104 is given a higher priority. After processing of each of the one or more text crop portions and the one or more orthogonally rotated text crop portions, the candidate recognized text string (i.e., the vertical trailer number) if found on more than one camera view (e.g., left and right view or right and rear view) then, that candidate recognized text string is chosen finally.

In some implementations, the text-character frequency parameter comprises, for each candidate text string, a count of how frequently the text string was output by the ensemble across the one or more images. In case, if any ambiguity exists in selecting the final recognized text string using the defined camera-based parameter, the text-character frequency parameter is used. In the text-character frequency parameter, the count of how frequently the text string is output by the ensemble across the one or more images is checked, and the most frequently seen text string is chosen.

In some implementations, the final recognized text string is identified as a vehicle trailer number based on matching a predefined character format and set. In an implementation, the final recognized text string may be identified as the vehicle trailer number based on the predefined character format and set. The vehicle trailer number is a unique identifier for each trailer along with its carrier and is used by the warehouse workers to identify, manage and perform downstream tasks on shipment and trailers.

In some implementations, the processor 110 is further configured to: query the database 122 using the identified vehicle trailer number to retrieve associated shipment information and trigger one or more supply chain management workflows based on the retrieved shipment information. In an implementation scenario, the database 122 (e.g., a Snowflake database) may be queried using the identified vehicle trailer number to retrieve associated shipment information, such as purchase document number, operation status of a specific event, and the like, and thereafter, the one or more supply chain management workflows can be triggered based on the retrieved shipment information.

Thus, the system 100 enables an efficient recognition of the vertically oriented alphanumeric text with enhanced accuracy and reliability. The system 100 uses the trained text detector 116 to identify the one or more regions-of-interest that comprises the vertically oriented alphanumeric text. The use of the trained text detector 116 ensures the more accurate identification of the regions comprising the vertically oriented alphanumeric text (such as, trailer's number, carrier's number, license number, USDOT number, etc.) in each image. Moreover, the system 100 uses the trained ensemble of two different text recognition models that is the first text recognition model 118A and the second text recognition model 118B, which recognize the vertically oriented alphanumeric text with more reliability and efficiency. Each of the first text recognition model 118A and the second text recognition model 118B is trained using the synthetic as well as real-world alphanumeric text samples, which make the first text recognition model 118A and the second text recognition model 118B more proficient in recognizing the vertically oriented alphanumeric text. Moreover, the system 100 ensures that the most confident and repeating texts found, are given more weight and the final text string is selected based on number of views found (e.g., the left view, right view, rear view, front view, etc.) and based on the weight or frequency of the final text string. Consequently, the final text string is selected with an enhanced accuracy and reliability and in a faster way.

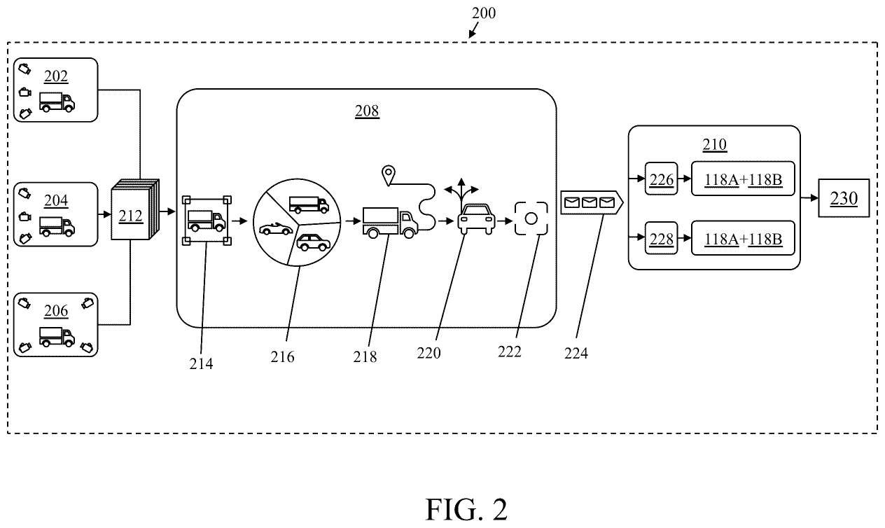

FIG. 2 is a diagram illustrating a subnetwork for detection and recognition of vertically oriented alphanumeric text, in accordance with an embodiment of the present disclosure. FIG. 2 is described in conjunction with elements from FIG. 1. With reference to FIG. 2, there is shown a subnetwork 200 of a number of cameras installed at different gates for example, a first gate 202, a second gate 204 and a third gate 206 of a warehouse. The subnetwork 200 further includes a Graphics Processing Unit (GPU) streaming module 208 and a GPU text spotting module 210.

The number of cameras (i.e., cameras installed on each gate) are Power-over-Ethernet cameras, for example, Gigabit Ethernet (GiGE) cameras which are equipped with Gigabit Ethernet interfaces which enables each camera to transmit data at high speeds over Ethernet networks. Generally, the GiGE cameras are configured to high-resolution imaging and high-speed data transfer over Ethernet networks. Moreover, all cameras are configured to stream multiple switches connected to the server 102 (installed in a server room of the warehouse) may be through a network closet Main Distribution Frame (MDF) switch. Each camera installed at each gate is connected to a Power over Ethernet (PoE) switch 212 that allows electrical power and data to be transmitted simultaneously over standard Ethernet cables.

In order to avoid bandwidth issues, the cameras installed at each gate are isolated into their own subnets and paired with a four port ethernet network card installed in the server 102 (i.e., the P7 workstation). This allows for streaming all cameras at 4k resolution at 5 Frames per second (FPS) with further room for addition. The cameras at each gate stream only to one port on the network card, and hence shares 1 GBPS bandwidth of that port effectively, allowing for real-time processing from all cameras. On the server 102, deep stream is used as a streaming network, which allows for streaming from all cameras directly to a processor (e.g., a GPU) of the server 102, where deep learning pipelines are run.

Firstly, all streams from all cameras are multiplexed, creating a batch of frames with their metadata. The batch of frames is sent to a Primary Inference Engine (e.g., Yolvo8), which is trained to localize and classify vehicles in each image. The classification of vehicles has significance, since multiple types of vehicles enter and exit the warehouse and all vehicles are required to be logged for security purposes. The classification of vehicles has been described in detail, for example, in FIG. 1. After vehicle detection and classification in each image, the server 102 is configured to detect one or more regions-of-interest in each image using the trained text detector 116 (of FIG. 1). The detected one or more regions-of-interest comprise the vertically oriented alphanumeric text. Thereafter, the server 102 is configured to execute a cropping of the detected one or more regions-of-interest encompassing corresponding vertically oriented alphanumeric text from each image and execute the trained ensemble of two different text recognition models (i.e., the first text recognition model 118A and the second text recognition model 118B) on each of the obtained one or more text crop portions and recognize the vertical text string as the vehicle trailer number. Various models, such as vehicle detection, vehicle classification, vehicle tracking, text detection and text recognition, run on the server 102 and configured to save the images in cropped format along with the predicted annotations. This allows for faster retraining and better accuracies achieved.

The GPU streaming module 208 typically refers to a hardware component or software framework designed to facilitate the streaming of graphics-intensive applications or content using the processing power of a GPU. The GPU streaming module 208 is configured to run on each camera installed at each gate for vehicle detection and classification. Moreover, the GPU streaming module 208 is configured to execute the steps 214 to 222. At step 214, a vehicle at any of the three gates of the warehouse is localized. At step 216, the vehicle is classified as whether the localized vehicle is either a truck with trailer, or a car, or a tractor without trailer. In a case, if the vehicle is identified as the car, then, no action is required. In another case, if the vehicle is classified as the truck with trailer, then, at step 218, the vehicle is tracked using the multiple cameras installed at the respective gate. After the vehicle detection and classification, a tracking module is used to maintain persistence of a vehicle (e.g., a truck) across the stream. The tracking module assigns a truck_id to the truck, and maintains the truck_id across its lifespan. In an implementation scenario, the tracking module may be deployed as a deep correlation filter supplemented with Kalman Filter for state estimation. Moreover, a Business Logic is added on top of the tracking module to ensure truck_ids from different streams at the same gate are associated together in case they are the same truck. The various images of the truck are saved into a folder based on deviancy in movement to ensure all sides and good angles of the truck are captured. At step 220, direction of the vehicle is also detected whether the vehicle is entering the warehouse or exiting the warehouse. After vehicle detection and classification, various images of the vehicle are saved in a storage space provided along with each camera installed at the respective gate, at step 222.

Once the vehicle has moved through the gate and various images of the vehicle capturing the sides and rear of the vehicle are stored, a message 224 is sent through a local host, named RabbitMQ message queue. The message 224 contains a folder path of the vehicle, the event and gate, a timestamp of the event, a type of the vehicle, etc. On the other side of the message queue, there are multiple listeners implemented using multiprocessing. Each listener listens for the message 224 and once the message 224 is received, begins the text spotting. The text spotting is performed using the GPU text spotting module 210. In FIG. 2, there is shown two listeners, such as a first listener 226 and a second listener 228 for the message 224. Each of the first listener 226 and the second listener 228 is configured to execute the trained ensemble of the first text recognition model 118A and the second text recognition model 118B on the message 224 to recognize the vertically oriented alphanumeric text (e.g., trailer number, USDOT number, carrier names, license number, etc.) spotted on the vehicle and provides the recognized vertically oriented alphanumeric text as an output at step 230.

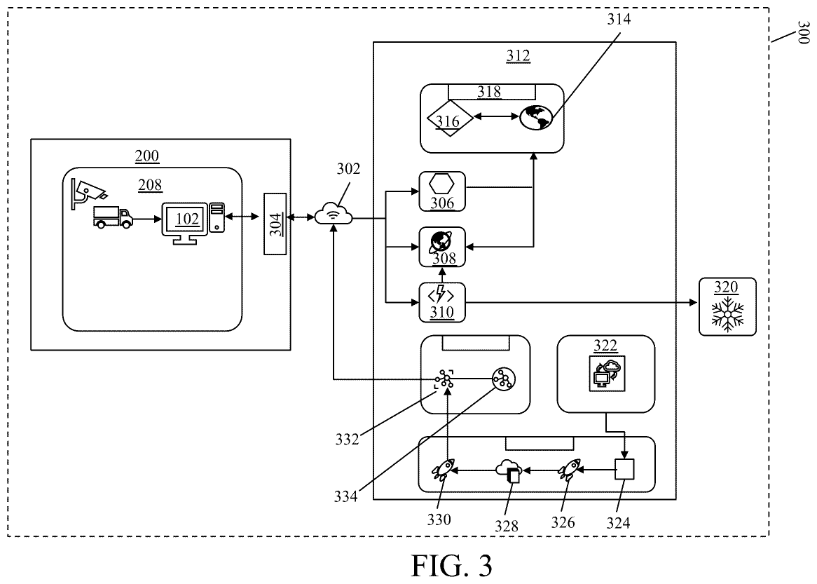

FIG. 3 is a diagram illustrating an overall solution architecture to display all information of vehicles entering to or from exiting a warehouse, in accordance with an embodiment of the present disclosure. FIG. 3 is described in conjunction with elements from FIGS. 1 and 2. With reference to FIG. 3, there is shown a network architecture 300 that displays all the information related to all the vehicles entering or exiting a warehouse. The network architecture 300 displays the subnetwork 200 (of FIG. 2) where, it has been shown that any vehicle entering to or exiting from different gates of the warehouse, is localized, detected and classified using the GPU streaming module 208. Each camera installed at each gate is configured for live streaming to the server 102 (of FIG. 1). The server 102 may also be termed as a central computer. In an implementation, the server 102 may be a workstation equipped with a 48 threads processor, and a 24 GB Virtual Random Access Memory (VRAM) graphical processing unit (GPU). The server 102 may be configured to execute a computer vision solution that maintains a log of all the vehicles entering and exiting the warehouse. The computer vision solution employs both hardware and software in form of cameras installed at each gate, the server 102, multiple deep learning algorithms running on the server 102, and a cloud for storing results, images and the like. The server 102 is configured to execute Artificial Intelligence (AI) algorithms to detect the trailer and execute the trained ensemble of two different text recognition models to extract the trailer number, USDOT number, carrier name, etc., which is provided as an output.

The server 102 is further configured to upload the output to a cloud server 302 through a firewall 304. Additionally, the server 102 may be configured to automatically collect the images captured by the cameras installed at each gate of the warehouse and perform pre-annotation of various image datasets. The cloud server 302 is further connected to various storage devices and database, such as a Binary large object (Blob) storage device 306, a Cosmos database 308 and an Azure function 310. Each of the Blob storage device 306, the Cosmos database 308 and the Azure function 310 corresponds to an Application Programming Interface (API) 312. The Blob storage device 306 and the Cosmos database 308 are connected to a web application 314 having an application gateway 316. The web application 314 and the application gateway 316 are part of a cloud application 318. The Blob storage device 306 is configured to display the various images of the trailer on the web application 314 and the Cosmos database 308 is configured to display all the information related to the trailer on the web application 314. The Azure function 310 is configured to fetch Purchasing Document Number (may also be referred to as Purchase Order (PO)), Stock Transport Number (STO) and Operation status for a specific event from a Snowflake database 320. The Azure function 310 is configured to save the fetched PO, STO and operation status in the Cosmos database 308. The API 312 may further display a number of Virtual Machines (VMs) 322 used for development and testing. The number of VMs 322 is connected to a source repository 324, a build pipeline 326, a container registry 328 and a release pipeline 330. The source repository 324 is configured to generate a build docker image which is provided as an input to the build pipeline 326. The build pipeline 326 is configured to push the docker image to the container registry 328 which is configured to generate the deployment manifest. The release pipeline 330 has further connection to an Internet-of-Things (IoT) hub 332 provided with a device provisioning service 334. The IoT hub 332 is connected to the cloud server 302.

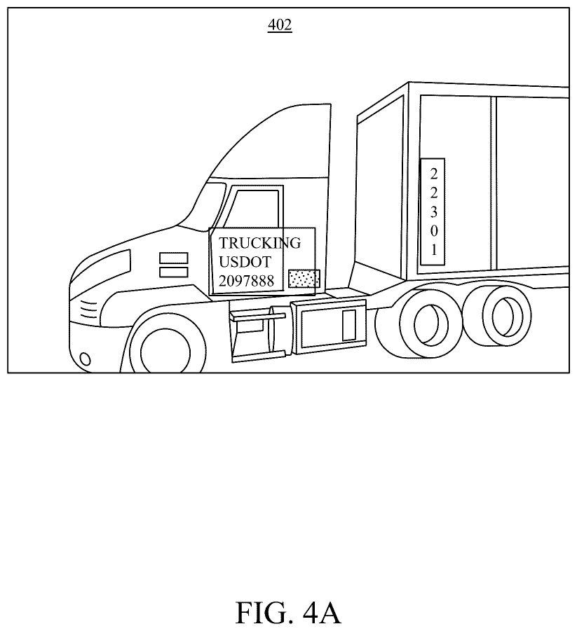

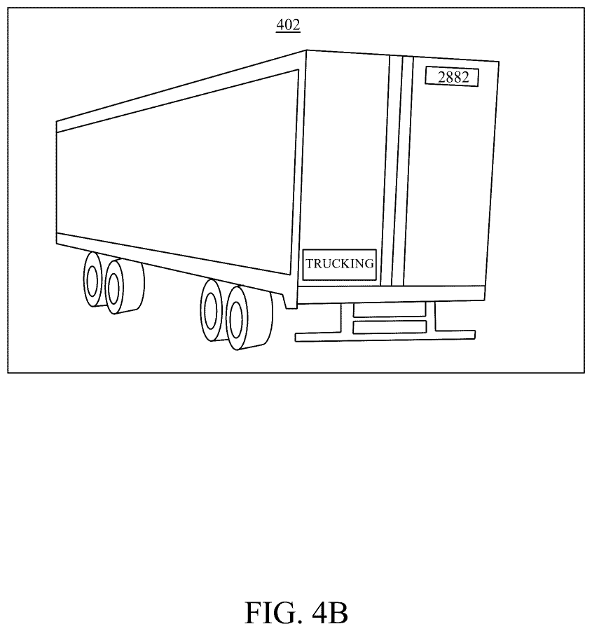

FIG. 4A is a diagram illustrating an exemplary implementation scenario of detection of vertically oriented alphanumeric text on a vehicle exiting from a warehouse, in accordance with an embodiment of the present disclosure. FIG. 4A is described in conjunction with elements from FIGS. 1, 2, and 3. With reference to FIG. 4A, there is shown a vehicle 402 exiting from a warehouse. The number of cameras installed at different gates of the warehouse are configured to capture images of both sides of the vehicle 402 as well as rear side of the vehicle 402. The trained text detector 116 (of FIG. 1) is configured to identify the region-of-interest from the captured images, comprising alphanumeric text including the vertically oriented alphanumeric text. The identified region-of-interest is cropped and passed to the ensemble of two different text recognition models, such as the first text recognition model 118A and the second text recognition model 118B. Each of the first text recognition model 118A and the second text recognition model 118B is executed on the cropped portions and orthogonally rotated cropped portions to determine one or more text strings available on the vehicle 402. The determined text strings represent USDOT number 2097888 and the carrier's name as ‘trucking’. The determined text strings also include vertically oriented alphanumeric text string represented as ‘22301’ which is a trailer number.

FIG. 4B is a diagram illustrating an exemplary implementation scenario of detection of vertically oriented alphanumeric text on a vehicle exiting from a warehouse, in accordance with another embodiment of the present disclosure. FIG. 4B is described in conjunction with elements from FIGS. 1, 2, 3 and 4A. With reference to FIG. 4B, there is shown the vehicle 402 exiting from the warehouse. On the rear side of the vehicle 402, the information, such as VIN number as ‘2882’ and the carrier's name as “trucking” is identified by the trained ensemble of the first text recognition model 118A and the second text recognition model 118B. The process of identifying the alphanumeric text including horizontal as well as vertically oriented text available on the rear side of the vehicle 402 is same as that of identifying the alphanumeric text including horizontal as well as vertically oriented, available on both sides of the vehicle 402, as described in detail, for example, in FIG. 4A.

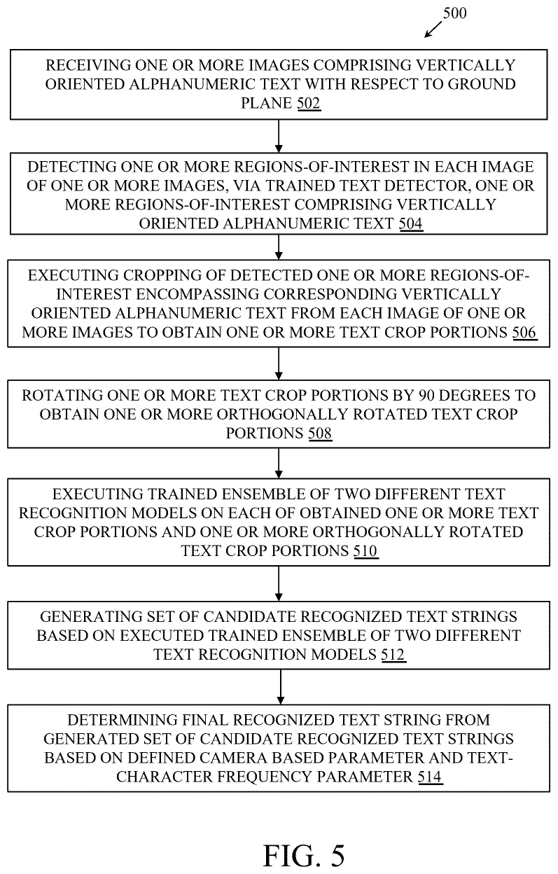

FIG. 5 is a flowchart of a method for recognizing vertically oriented alphanumeric text in images, in accordance with an embodiment of the present disclosure. FIG. 5 is described in conjunction with the elements of FIGS. 1, 2, 3, 4A and 4B. With reference to FIG. 5, there is shown a method 500 for recognizing vertically oriented alphanumeric text in images. The method 500 includes steps from 502 to 514. The processor 110 of the server 102 is configured to execute the method 500.

At step 502, the method 500 comprises receiving, by the processor 110, one or more images comprising vertically oriented alphanumeric text with respect to a ground plane. In an implementation, the received one or more images correspond to images of vehicles entering to or exiting from a warehouse. The images of vehicles comprise vertically oriented alphanumeric text as well as horizontally oriented alphanumeric text, which represents trailer's number, carrier's name, license number, VIN number, MC number, and the like.

At step 504, the method 500 further comprises detecting, by the processor 110, one or more regions-of-interest in each image of the one or more images, via a trained text detector, the one or more regions-of-interest comprising the vertically oriented alphanumeric text. The one or more regions-of-interest correspond to the regions in each image where the vertically oriented alphanumeric text is detected by the trained text detector 116 (of FIG. 1).

In some implementations, the method 500 further comprises training the trained text detector 116 using a third training dataset (e.g., the third training dataset 120C) generated by overlaying alphanumeric characters on backgrounds scraped from various trailers and applying realistic font styles commonly found in the trucking industry. The third training dataset 120C may be used to fine-tune the trained text detector 116 based on real image samples as well as synthetic image samples. The synthetic image samples are generated using the following: alphanumeric characters are overlaid on backgrounds, scraped from various trailers at different sizes, width and height ratios.

In some implementations, the generated third training dataset 120C further comprises synthetic images generated by: sampling background images from the real images of vehicle trailers, rendering vertically oriented text strings onto the sampled background images using fonts commonly found on vehicle trailers, and applying one or more data augmentation techniques to the rendered text strings. The synthetic image samples (or synthetic images) comprised by the third training dataset 120C may be generated using a variety of text sampling methods, such as random text, substrings sampled from a trailer database, full text sampled from the trailer database, and the like.

In some implementations, the one or more data augmentation techniques comprise one or more of: skewing, perspective transforming, adjusting character spacing, adding noise patterns, or applying spatial dropout. The one or more data augmentation techniques are used to generate more synthetic image samples from real images by applying various transformation to the original data. The use of the one or more data augmentation techniques may increase the diversity of the third training dataset 120C by introducing variations, such as rotations, translations, flipping, cropping, brightness adjustments, noise addition, and the like.

At step 506, the method 500 further comprises executing, by the processor 110, a cropping of the detected one or more regions-of-interest encompassing corresponding vertically oriented alphanumeric text from each image of the one or more images to obtain one or more text crop portions. The one or more regions-of-interest comprising the vertically oriented alphanumeric text (e.g., a trailer number, USDOT number, tractor carrier name, trailer carrier name, and license number plate) are detected and cropped from each image to obtain the one or more text crop portions.

At step 508, the method 500 further comprises rotating, by the processor 110, the one or more text crop portions by 90 degrees to obtain one or more orthogonally rotated text crop portions. The obtained one or more text crop portions and the one or more orthogonally rotated text crop portions are used for detection of the vertically oriented alphanumeric text and the horizontally oriented alphanumeric text, respectively.

At step 510, the method 500 further comprises executing, by the processor 110, a trained ensemble of two different text recognition models on each of the obtained one or more text crop portions and the one or more orthogonally rotated text crop portions. The trained ensemble of two different text recognition models, such as the first text recognition model 118A and the second text recognition model 118B is executed on each of the obtained one or more text crop portions and the one or more orthogonally rotated text crop portions for the more reliable detection of the vertically oriented alphanumeric text.

In some implementations, the trained ensemble of two different text recognition models comprises the first text recognition model 118A trained on the first training dataset 120A comprising a plurality of vertically oriented synthetic and real-world alphanumeric text samples. In an implementation, the first text recognition model 118A may correspond to a deep learning model, for example a Paddle OCR model, which is trained on the first training dataset 120A. The first training dataset 120A comprises, for example, 50K images including real-world alphanumeric text samples and 50K images of synthetic vertical samples.

In some implementations, the trained ensemble of two different text recognition models comprises the second text recognition model 118B trained on the second training dataset 120B comprising a plurality of rotated vertically oriented synthetic and real-world alphanumeric text samples. Similar to the first text recognition model 118A, the second text recognition model 118B may also correspond to a deep learning model, for example a transformed OCR (Tr-OCR) model, which is trained on the second training dataset 120B. The second training dataset 120B comprises, for example, 50K images including real-world alphanumeric text samples and 50K images of synthetic rotated vertical samples (i.e., orthogonally rotated vertically oriented samples).

At step 512, the method 500 further comprises generating, by the processor 110, a set of candidate recognized text strings based on the executed trained ensemble of two different text recognition models. Each of the first text recognition model 118A and the second text recognition model 118B is executed on the one or more text crop portions and the one or more orthogonally rotated text crop portions, respectively. After execution, outputs are generated in form of the set of candidate recognized text strings from each of the first text recognition model 118A and the second text recognition model 118B.

At step 514, the method 500 further comprises determining, by the processor 110, a final recognized text string from the generated set of candidate recognized text strings based on a defined camera based parameter and a text-character frequency parameter. The final recognized text string (e.g., a vertical trailer number) is determined from the generated set of candidate recognized text strings based on which text string is recognized across camera views and which text string is most frequently recognized.

In some implementations, the defined camera-based parameter is indicative of a number of camera views from which the detected region-of-interest is captured, and where a candidate recognized text string from the generated set of candidate recognized text strings identified in the same detected region-of-interest by the two or more cameras 104 is given a higher priority. After processing of each of the one or more text crop portions and the one or more orthogonally rotated text crop portions, the candidate recognized text string (i.e., the vertical trailer number) if found on more than one camera view (e.g., left and right view or right and rear view) then, that candidate recognized text string is chosen finally.

In some implementations, the text-character frequency parameter comprises, for each candidate text string, a count of how frequently the text string was output by the ensemble across the one or more images. In case, if any ambiguity exists in selecting the final recognized text string using the defined camera-based parameter, the text-character frequency parameter is used. In the text-character frequency parameter, the count of how frequently the text string is output by the ensemble across the one or more images is checked, and the most frequently seen text string is chosen.

In some implementations, the final recognized text string is identified as a vehicle trailer number based on matching a predefined character format and set. In an implementation, the final recognized text string may be identified as the vehicle trailer number based on the predefined character format and set.

In some implementations, the method 500 further comprises querying the database 122 using the identified vehicle trailer number to retrieve associated shipment information and trigger one or more supply chain management workflows based on the retrieved shipment information. In an implementation scenario, the database 122 (e.g., the snowflake database 320 of FIG. 3) may be queried using the identified vehicle trailer number to retrieve associated shipment information, such as purchase document number, operation status of a specific event, and the like, and thereafter, the one or more supply chain management workflows can be triggered.

The steps 502 to 514 are only illustrative, and other alternatives can also be provided where one or more steps are added, or one or more steps are provided in a different sequence without departing from the scope of the claims herein.

There is provided a computer program comprising instructions for carrying out all the steps of the method 500. The computer program is executed on a computer system. The computer program is implemented as an algorithm, embedded in a software stored in the non-transitory computer-readable storage medium having program instructions stored thereon, the program instructions being executable by the one or more processors in the computer system to execute the method 500. The non-transitory computer-readable storage means may include, but are not limited to, an electronic storage device, a magnetic storage device, an optical storage device, an electromagnetic storage device, a semiconductor storage device, or any suitable combination of the foregoing. Examples of implementation of computer-readable storage medium, but are not limited to, an Electrically Erasable Programmable Read-Only Memory (EEPROM), a Random Access Memory (RAM), a Read Only Memory (ROM), a Hard Disk Drive (HDD), a Flash memory, a Secure Digital (SD) card, a Solid-State Drive (SSD), a computer-readable storage medium, and/or a CPU cache memory.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A system for recognizing vertically oriented alphanumeric text in images, the system comprising:
a processor configured to:
receive one or more images comprising vertically oriented alphanumeric text with respect to a ground plane;
detect one or more regions-of-interest in each image of the one or more images, via a trained text detector, the one or more regions-of-interest comprising the vertically oriented alphanumeric text;
execute a cropping of the detected one or more regions-of-interest encompassing corresponding vertically oriented alphanumeric text from each image of the one or more images to obtain one or more text crop portions;
rotate the one or more text crop portions by 90 degrees to obtain one or more orthogonally rotated text crop portions;
execute a trained ensemble of two different text recognition models on each of the obtained one or more text crop portions and the one or more orthogonally rotated text crop portions;
generate a set of candidate recognized text strings based on the executed trained ensemble of two different text recognition models; and
determine a final recognized text string from the generated set of candidate recognized text strings based on a defined camera based parameter and a text-character frequency parameter.

2. The system of claim 1, wherein the defined camera based parameter is indicative of a number of camera views from which the detected region-of-interest is captured, and wherein a candidate recognized text string from the generated set of candidate recognized text strings identified in the same detected region-of-interest by two or more cameras is given a higher priority.

3. The system of claim 1, wherein the text-character frequency parameter comprises, for each candidate text string, a count of how frequently the text string is output by the trained ensemble across the one or more images.

4. The system of claim 1, wherein the trained ensemble of two different text recognition models comprises a first text recognition model trained on a first training dataset comprising a plurality of vertically oriented synthetic and real-world alphanumeric text samples.

5. The system of claim 1, wherein the trained ensemble of two different text recognition models comprises a second text recognition model trained on a second training dataset comprising a plurality of rotated vertically oriented synthetic and real-world alphanumeric text samples.

6. The system of claim 1, wherein the final recognized text string is identified as a vehicle trailer number based on matching a predefined character format and set.

7. The system of claim 6, wherein the processor is further configured to: query a database using the identified vehicle trailer number to retrieve associated shipment information; and trigger one or more supply chain management workflows based on the retrieved shipment information.

8. The system of claim 1, wherein the processor is configured to train the trained text detector using a third training dataset generated by overlaying alphanumeric characters on backgrounds scraped from various trailers and applying realistic font styles commonly found in a trucking industry.

9. The system of claim 8, wherein the generated third training dataset further comprises synthetic images generated by: sampling background images from the real images of vehicle trailers; rendering vertically oriented text strings onto the sampled background images using fonts commonly found on vehicle trailers; and applying one or more data augmentation techniques to the rendered text strings.

10. The system of claim 9, wherein the one or more data augmentation techniques comprise one or more of: skewing, perspective transforming, adjusting character spacing, adding noise patterns, or applying spatial dropout.

11. A method, comprising:
receiving, by a processor, one or more images comprising vertically oriented alphanumeric text with respect to a ground plane;
detecting, by the processor, one or more regions-of-interest in each image of the one or more images, via a trained text detector, the one or more regions-of-interest comprising the vertically oriented alphanumeric text;
executing, by the processor, a cropping of the detected one or more regions-of-interest encompassing corresponding vertically oriented alphanumeric text from each image of the one or more images to obtain one or more text crop portions;
rotating, by the processor, the one or more text crop portions by 90 degrees to obtain one or more orthogonally rotated text crop portions;
executing, by the processor, a trained ensemble of two different text recognition models on each of the obtained one or more text crop portions and the one or more orthogonally rotated text crop portions;
generating, by the processor, a set of candidate recognized text strings based on the executed trained ensemble of two different text recognition models; and
determining, by the processor, a final recognized text string from the generated set of candidate recognized text strings based on a defined camera based parameter and a text-character frequency parameter.

12. The method of claim 11, wherein the defined camera based parameter is indicative of a number of camera views from which the detected region-of-interest is captured, and wherein a candidate recognized text string from the generated set of candidate recognized text strings identified in the same detected region-of-interest by two or more cameras is given a higher priority.

13. The method of claim 11, wherein the text-character frequency parameter comprises, for each candidate text string, a count of how frequently the text string is output by the trained ensemble across the one or more images.

14. The method of claim 11, wherein the trained ensemble of two different text recognition models comprises a first text recognition model trained on a first training dataset comprising a plurality of vertically oriented synthetic and real-world alphanumeric text samples.

15. The method of claim 11, wherein the trained ensemble of two different text recognition models comprises a second text recognition model trained on a second training dataset comprising a plurality of rotated vertically oriented synthetic and real-world alphanumeric text samples.

16. The method of claim 11, wherein the final recognized text string is identified as a vehicle trailer number based on matching a predefined character format and set.

17. The method of claim 16, wherein the method further comprises querying a database using the identified vehicle trailer number to retrieve associated shipment information; and trigger one or more supply chain management workflows based on the retrieved shipment information.

18. The method of claim 11, wherein the method further comprises training the trained text detector using a third training dataset generated by overlaying alphanumeric characters on backgrounds scraped from various trailers and applying realistic font styles commonly found in a trucking industry.

19. The method of claim 18, wherein the generated third training dataset further comprises synthetic images generated by: sampling background images from the real images of vehicle trailers; rendering vertically oriented text strings onto the sampled background images using fonts commonly found on vehicle trailers; and applying one or more data augmentation techniques to the rendered text strings.

20. The method of claim 19, wherein the one or more data augmentation techniques comprise one or more of: skewing, perspective transforming, adjusting character spacing, adding noise patterns, or applying spatial dropout.
